(19) United States
(12) Patent Application Publication
(10) Pub. No.: US 2025/0382166 A1
(43) Pub. Date: Dec. 18, 2025

(54) WORKING MACHINE

(71) Applicant: J.C. BAMFORD EXCAVATORS LIMITED, Uttoxeter (GB)

(72) Inventor: Tom Rushton, Uttoxeter (GB)

(21) Appl. No.: 19/236,156

(22) Filed: Jun. 12, 2025

(30) Foreign Application Priority Data
Jun. 12, 2024 (GB) 2408416.2

(51) Int. Cl. B66F 9/075; B66F 9/065; E02F 9/26

(52) U.S. Cl. CPC B66F 9/0755; B66F 9/065; E02F 9/265

(57) ABSTRACT

A working machine having a camera assembly arranged to monitor a working arm assembly and a portion of the working machine. The working machine includes a control system configured to determine the relative positions of the working arm assembly and the portion of the working machine based on outputs from the camera assembly, and to restrict or prevent movement of the working arm assembly to prevent a collision.

### FIELD

The present teachings relate to a working machine.

### BACKGROUND

Off-highway vehicles/working machines are typically those used in construction industries (e.g., backhoe loaders, slew excavators, telescopic handlers, forklifts, skid-steer loaders, dump trucks, bulldozers, graders), agricultural industries (e.g., tractors, combine harvesters, wheeled loading shovels, telescopic handlers, self-propelled harvesters and sprayers), quarrying (e.g., excavators, wheeled loading shovels, aggregate crushing equipment), and forestry (e.g., timber harvesters, feller bunchers). Many working machines have a primary function of moving material using either a lifting arm (e.g., a pivoting boom) or a working arm (e.g., an excavator arm) and may be referred to as material handling machines. Telehandlers are generally well known and comprise a vehicle with a pivoting telescopically extending lifting arm which allows items to be transported between different locations at varying heights with relative ease and flexibility. Telehandlers are often utilized in agriculture, construction or logistics, amongst other sectors.

Working arms or lifting arms typically have a working implement, such as a bucket, forks, or a grabber, attached to the end of the arm via a coupling device. Attachment of the working implement enables the working machine to perform a variety of tasks on a work site. Some of these tasks involve moving the working arm and implement into a large number of different positions relative to the off-highway vehicle or working machine, some of which may be at risk of causing a collision between the working arm and/or implement and another part of the off-highway vehicle or working machine.

The present teachings seek to overcome or at least mitigate one or more problems associated with the prior art.

### SUMMARY

The present teachings provide a working machine according to the appended claims.

A working machine comprises a ground engaging propulsion structure, a body supported on the ground engaging propulsion structure, a working arm assembly comprising a working arm pivotally mounted to the body, said working arm comprising a working implement mount at a distal portion thereof.

The working machine may comprise a sensor assembly arranged to monitor the working arm assembly and at least one further portion of the working machine.

The working machine may comprise a control system configured to determine the relative positions of the working arm assembly and the at least one further portion of the working machine based on outputs from the sensor assembly, and to restrict or prevent movement of the working arm assembly to prevent the working arm assembly colliding with the at least one further portion of the working machine.

This prevents the working arm from colliding with parts of the working machine during operation of the arm, which could result in damage to the machine. Providing a control system that is capable of determining the relative positions of the working arm and other parts of the working machine and to prevent collision occurring, may enable a wider range of carriages and/or working implements to be mounted onto the working arm, i.e., for instances where a particular carriages/implement may not be used due to their being a high risk of collisions occurring.

The control system may be configured to determine whether the working arm assembly comprises a carriage and/or a working implement mounted to the working implement mount based on an output from the sensor assembly, and to restrict or prevent movement of the working arm assembly to prevent the carriage and/or working implement colliding with the at least one further portion of the working machine.

Detecting the presence of a carriage and/or working implement helps to prevent the carriage and/or working implement from colliding with parts of the working machine during operation of the arm, which could result in damage to the machine.

The control system may be configured to identify the type of carriage and/or working implement mounted to the working implement mount, e.g., an identifier on said working implement.

Identifying the type of carriage and/or working implement mounted to the working arm enables the size and shape to be known, which has been found to further reduce the risk of a collision occurring.

The control system may comprise a processor configured to execute a machine learning algorithm to identify whether a carriage and/or a working implement is mounted to the working implement mount.

This helps to prevent the carriage and/or working implement from colliding with parts of the working machine during operation of the arm, which could result in damage to the machine.

The processor may be configured to execute a machine learning algorithm to identify whether a load is being carried by the working arm assembly, and wherein the control system is configured to provide a warning, alert, or notification when the load is within a predetermined distance from the further part of the working machine.

The control system may be configured to restrict or prevent movement of the working arm assembly to prevent the load colliding with the at least one further portion of the working machine.

The sensor assembly may be arranged to monitor at least a part of the ground engaging propulsion structure, and the control system may be configured to restrict or prevent movement of the working arm assembly to prevent the working arm assembly colliding with the ground engaging propulsion structure.

During operation of the working arm, a carriage or implement may be operated so as to impact the ground engaging propulsion structure, so knock off the tires or tracks. Defining an impact zone around the ground engaging propulsion structure helps to prevent these impacts/collisions occurring.

When the ground engaging propulsion structure is provided in the form of front and rear wheels, the control system may be configured to restrict or prevent turning of one or more of said wheels to prevent the wheel from colliding with the working arm assembly.

The control system may comprise a processor configured to execute a machine learning algorithm to identify the ground engaging propulsion structure on the working machine, and to output information on the size and shape of the ground engaging propulsion structure to the control system.

The working machine may comprise an operator cab mounted on the body. The sensor assembly may be configured to monitor at least a part of the operator cab, and to restrict or prevent movement of the working arm assembly to prevent the working arm assembly colliding with the operator cab.

During operation of the working arm, a carriage or implement may be operated so as to impact the operator cab. Defining an impact zone around the operator cab helps to prevent these impacts/collisions occurring.

The control system may be configured to define a minimum permitted distance between the working arm assembly and the at least one further portion of the working machine.

This further helps to avoid impacts occurring.

The control system may be configured to provide a gradual stop of the working arm to prevent the working arm assembly colliding with the at least one further portion of the working machine.

This improves operator control and prevents a sudden abrupt stop.

The control system may be configured to restrict or limit a speed of movement of the working arm assembly when a spacing between the working arm assembly and the at least one further portion of the working machine is below a first pre-determined distance.

The control system may be configured to prevent movement of the working arm assembly when a spacing between the working arm assembly and the at least one further portion of the working machine is below a second pre-determined distance, which is less than the first predetermined distance.

The control system may be configured to restrict or prevent movement of the working arm assembly by controlling or restricting one or more of: raising of the working arm; lowering of the working arm; extension or retraction of the working arm, when the working arm is a telescopic working arm; and crowding or dumping of a carriage and/or working implement, when the working arm assembly comprises said carriage and/or working implement.

The body may comprise an undercarriage and a superstructure rotatably mounted to the undercarriage, and the working arm may be pivotally mounted to the superstructure.

The control system may be configured to restrict or prevent rotational movement of the superstructure to restrict or prevent movement of the working arm assembly.

The control system may be configured to define a first zone encompassing a part of the working arm assembly and to define at least one impact zone corresponding to the at least further one part or portion of the working machine, and to determine the relative positions of the first zone and at least one impact zone based on outputs from the sensor assembly, and to restrict or prevent movement of the working arm assembly to prevent the first zone from contacting the at least one impact zone.

In some instances the working arm assembly comprises a carriage and/or working implement that is not specifically designed for that particular working machine. Defining a zone around the peripheral edge of the carriage and/or working implement enables these different carriages or working implements to be used with the working machine with less risk of a collision occurring.

The control system may comprise an override control to allow the working arm assembly to be moved in a direction away from the at least one further portion of the working machine. The override control may be manually operated or automatic.

The control system may be configured to determine a permitted movement of the working arm assembly way from the at least one further portion of the working machine based on outputs from the sensor assembly.

The control system may be configured to automatically reverse a direction of travel of the working arm assembly to move the working arm assembly in a direction away from the at least one further portion of the working machine.

The sensor assembly may comprise a camera assembly comprising at least one camera.

The working machine may comprise a display configured to display outputs from the camera assembly.

The display may be configured to operate in a plurality of display modes comprising a camera display mode in which the outputs from the camera assembly are displayed and at least one other display mode, and wherein, when movement of the working arm assembly has been restricted or prevented, the control system is configured to override the selection of the at least one other display mode to display the relative positions of the working arm assembly and the at least one further portion of the working machine.

The working machine may comprise an alarm or alert, and wherein the control system is configured to activate the alarm or alert when movement of the working arm assembly has been prevented or restricted.

### BRIEF DESCRIPTION OF THE DRAWINGS

Embodiments will now be described with reference to the accompanying drawings, in which:

FIGS. 1 and 2 show a material handling machine according to the present disclosure;

FIG. 3 is a schematic plan view of the working machine of FIG. 1 illustrating the field of view of the cameras; and

FIG. 4 shows the control system of the working machine of FIG. 1.

### DETAILED DESCRIPTION OF EMBODIMENT(S)

In the following detailed description, numerous specific details are set forth in order to provide a thorough understanding of various embodiments and the inventive concept. However, those skilled in the art will understand that: the present invention may be practiced without these specific details or with known equivalents of these specific details; that the present invention is not limited to the described embodiments; and, that the present invention may be practiced in a variety of alternative embodiments. It will also be appreciated that well known methods, procedures, components, and systems may not have been described in detail.

References to vertical and horizontal in the present disclosure should be understood to be in relation to the machine when stood on horizontal ground in a non-working condition. The term axial is generally used in relation to the longitudinal axis of the machine. The term width is generally used in relation to the longitudinal length, that is, transverse to the length.

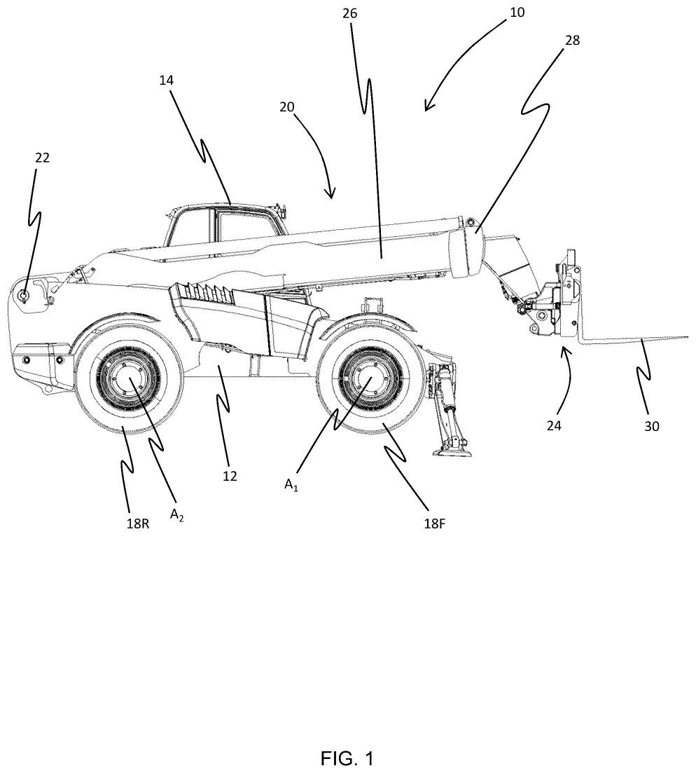

Referring firstly to FIG. 1, an embodiment of the teachings includes a working machine 10. The working machine may be a load handling machine. In this embodiment, the load handling machine 10 is a telescopic handler. In other embodiments the load handling machine 10 may be a rotating telescopic handler, a forklift, an excavator, a skid-steer loader, a compact track loader, a wheel loader, or a telescopic wheel loader, a tractor, for example. Such working machines may be denoted as off-highway vehicles or as non-road mobile machinery.

The working machine 10 includes a machine body 12. The machine body 12 may include, for example, an operator's cab 14 from which an operator can operate the machine 10. The operator cab 14 may be mounted on the body 12 so as to be offset from a center of the body. Although in alternative arrangements, the cab 14 may be substantially central.

The working machine 10 has a ground engaging propulsion structure or arrangement. The ground engaging propulsion structure supports the body 12. The working machine includes a working arm assembly. The working arm assembly includes a working arm 20 pivotally connected to the body 12. Put another way, the working arm 20 is mounted to the body 12 so as to be pivotable about a substantially horizontal, or pivot, axis. The working arm 20 is connected to the body 12 by a mount 22 proximate a first end, or proximal end, of the working arm 20.

The body 12 may include an undercarriage or chassis including the ground engaging propulsion arrangement, and a superstructure. The superstructure may include the cab and arm. In some arrangements, the superstructure may be rotatable (e.g., about a substantially vertical axis) relative to the undercarriage/chassis. Put another way, the superstructure may be rotatable relative to the ground engaging propulsion structure. It will be appreciated that the mount 22 may be provided on the undercarriage/chassis or the superstructure.

The ground engaging propulsion structure includes a first, or front, axle A1 and a second, or rear, axle A2. Each axle A1, A2 being coupled to a pair of wheels 16F, 16R, 18F, 18R. In other embodiments, the ground engaging propulsion structure may include a pair of endless tracks. One or both of the axles A1, A2 may be coupled to a drive arrangement (not shown) configured to drive movement of the ground engaging propulsion structure (i.e., the axles). The drive arrangement causes movement of the working machine 10 over a ground surface. The drive arrangement includes a primer mover and a transmission. The prime mover may be an internal combustion engine, an electric motor, or may be a hybrid comprising both an internal combustion engine, an electric motor.

In the present embodiment, the working arm 20 is a telescopic working arm. The telescopic arm includes a first section 26 connected to the mount 22 and a second section 28 which is telescopically fitted to the first section 26. In this embodiment, the second section 28 of the working arm 20 is telescopically moveable with respect to the first section 26 such that the working arm 20 can be extended and retracted. Movement of the second section 28 with respect to the first section 26 of the working arm 20 may be achieved by use of an extension actuator (not shown), for example a double acting hydraulic linear actuator, an electric linear actuator, a telescopic extension ram, multiple extension rams, and/or a chain and pulley system. As will be appreciated, the working arm 20 may include a plurality of sections, for example two, three, four or more sections. Each arm section may be telescopically fitted to at least one other section, and an actuator may be provided therebetween. In alternative arrangements, the working arm 20 may not be telescopic and may include a first am pivotally mounted to the mount 22. In such arrangements, the working arm 20 may or may not also include a second arm pivotally mounted to the first arm.

The working arm 20 can be moved with respect to the machine body 12 and the movement is preferably, at least in part, rotational movement about the mount 22. The rotational movement is about a substantially transverse axis of the machine 10 (i.e., about a horizontal axis). Rotational movement of the working arm 20 with respect to the machine body 12 is, in an embodiment, achieved by use of at least one lifting actuator (not shown) coupled between the arm 20 and the body 12.

A distal portion 21 of the working arm 20 includes a working implement mount. In the illustrated embodiment, the working arm assembly includes a working implement 30 mounted to a distal end of the working arm 20, i.e., to the working implement mount. In the arrangement shown, the working arm assembly includes a carriage assembly 24 mounted to the working implement mount and the working implement, e.g., a load handling implement, 30 mounted to the carriage assembly 24. In some arrangements, the carriage or carriage assembly 24 may be omitted. The working machine 10 is configured to transport loads over uneven ground, i.e., with a load held by the working implement 30, an operator controls the ground engaging propulsion structure to move the machine 10 with the load from one location to another. In the illustrated arrangement, the working implement is a pair of forks 30, e.g., a pair of laterally spaced apart forks. The forks 30 project forwardly from the carriage assembly 24. In alternative arrangements, the working implement 30 may be a bucket, or a basket etc., or any other suitable working implement.

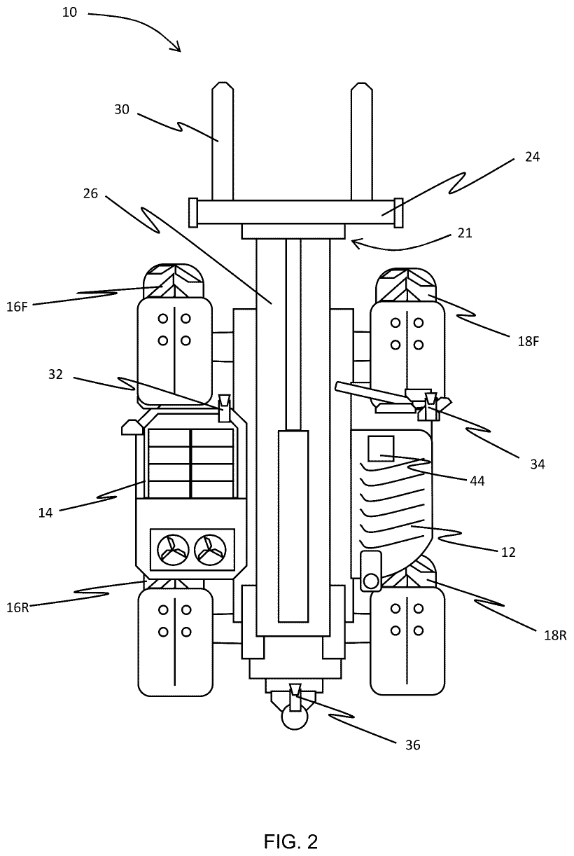

Referring now to FIG. 2, the working machine 10 is provided with a sensor assembly arranged to monitor different portions or parts of the working machine 10. In the present embodiment, the sensor assembly is configured and arranged to monitor the working arm assembly. It will be understood that the sensor assembly may monitor any part or parts of the working arm assembly, for example the distal portion 21 of the working arm, the carriage 24, the working implement 30, or any other part of the working arm 20.

The sensor assembly is also configured to monitor at least one further portion of the working machine 10. In the present embodiment, the sensor assembly is configured to monitor the ground engaging propulsion structure, for example the front wheels 16F, 18F, and the operator cab 14. It will be appreciated that any suitable portion of the working machine 10 may be monitored by the sensor assembly, for example the body 12, a side pod etc. In the present embodiment, the sensor assembly is provided in the form of a camera assembly including one or more cameras, as discussed in more detail below. In alternative embodiments, however, it will be understood that the any suitable sensor may be used that is capable of monitoring the relative positions of the working arm assembly and the rest of the working machine 10.

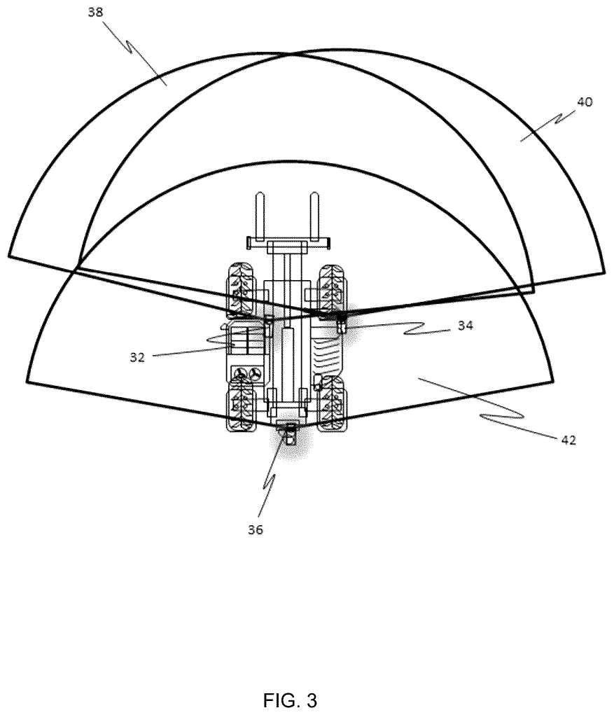

Referring now to FIG. 3, the camera assembly includes a first camera 32 mounted on the working machine 10. The first camera 32 is configured to monitor an area 38. In the illustrated embodiment, the first camera 32 is mounted on, in or proximate to the operator cab 14. In the illustrated embodiment, the camera assembly includes a second camera 34 mounted on the body 12 of the working machine 10 and configured to monitor an area 40. The second camera may be arranged on an opposite side of the working machine 10 to the first camera 32. The camera assembly may further include a third camera 36 mounted to the body that is configured to monitor an area 42. The third camera 36 may be mounted towards the rear of the working machine 10, for example at a location behind the working arm 20. In alternative arrangements, any one or more of the first, second and third cameras 32, 34, 36 may be used. Moreover, in some embodiments more or fewer cameras may be used, and that any number of cameras at any suitable location may be used, so long as they are capable of monitoring the desired parts of the working machine 10.

Referring again to FIGS. 1 and 2, the working machine 10 includes a control system 44. The control system 44 is configured to determine the relative positions of the working arm assembly and at least one further portion of the working machine 10 based on outputs from the camera assembly 32, 34, 36. The control system 44 is further configured to restrict or prevent movement of the working arm assembly to prevent the working arm assembly colliding with the at least one further portion of the working machine 10. In some embodiments, the further portion of the working machine 10 may be one or more of: front wheels of the ground engaging propulsion structure; rear wheels of the ground engaging propulsion structure; tracks; an operator cab; stabilizer legs; the side pod; the body 12; or any other suitable location on the working machine 10 that may collide with the working arm assembly during operation of the working machine 10.

Restricting or preventing movement of the working arm assembly may include one or more of: restricting or preventing pivoting (i.e., raising and/or lowering) of the working arm 20 relative to the body 12; restricting or preventing extension and retraction of the working arm 20; restricting or preventing pivoting (i.e., crowding and/or dumping) of the carriage 24 and/or working implement 30 mounted to the working arm 20; limiting a speed of movement of the working arm 20; providing a gradual stop of the working arm 20; and/or limiting or preventing a change of direction of the working arm 20. Additionally or alternatively, restricting or inhibiting movement of the working arm 20 may be provided in the form of providing a gradual stop of the working machine 10. The rate of the gradual stop may be based on one or more of: proximity of the working arm assembly to the further portion of the working machine 10; the load carried by the working arm 20; travel speed of the working machine 10; and/or the position of the working arm 20.

The prime mover may be configured to provide motive power to a hydraulic pump (not shown). The hydraulic pump may be used to drive hydraulic actuators required for the operation of the working arm assembly, e.g., for raising and lowering the working arm 20, for extending and retracting the working arm 20, or for crowding or dumping the carriage 24 and/or working implement 30. It will be appreciated that where movement of the working arm assembly is restricted by the control system 44, this may be achieved by controlling or restricting the flow of hydraulic fluid to the actuators controlling the relevant function of the working arm assembly. In alternative arrangements however, it will be appreciated that different types of actuators may be used, for example electronic actuators, and so controlling or restricting movement of the working arm assembly may be achieved through different means.

In alternative embodiments of the working machine 10 where the body 12 has an undercarriage and a superstructure rotatably mounted to the undercarriage, with the working arm 20 pivotally mounted to the superstructure, the control system 44 may be configured to restrict or prevent rotational movement of the superstructure to restrict or prevent movement of the working arm assembly.

The control system 44 may be configured to only restrict or inhibit movement of the working arm assembly in a direction towards the further portion of the working machine 10. The control system 44 may be configured to prevent a change in a direction of movement of a part or all of the working arm assembly in a direction towards the further portion of the working machine 10.

In some embodiments, the control system 44 may be configured to define a minimum permitted distance between the distal portion 21 of the working arm 20 and the at least one further portion of the working machine 10. It will be understood that the minimum permitted distance may differ depending on the type of working machine, the sensor assembly used, and the hydraulic responsiveness of the working machine 10. In some embodiments, the minimum permitted distance may be in the range 5-15 cm, for example approximately 10 cm, but it will be appreciated that any suitable distance may be used.

The control system 44 may be configured to restrict or limit a speed of movement of the working arm assembly when a spacing between the distal portion 21 of the working arm assembly and the at least one further portion of the working machine 10 is below a first pre-determined distance. The control system 44 may further be configured to prevent movement of the working arm assembly when a spacing between the working arm assembly and the at least one further portion of the working machine is below a second pre-determined distance, which is less than the first predetermined distance.

In some embodiments, the control system 44 may be provided with an override control to allow the working arm assembly to be moved in a direction away from the further portion of the working machine 10. In such embodiments, the working machine 10 may include an override button, control or switch (not shown) to activate the override control. The control system 44 may determine what is a permitted direction of movement (i.e., to move the working arm assembly away from the further portion of the working machine 10) based on outputs from the camera assembly. In some embodiments, when the override control is activated, the control system 44 may automatically reverse a direction of travel of the working arm assembly to move the working arm assembly away from the further portion of the working machine 10. It will be appreciated, however, that in some embodiments, the override control may be omitted.

The control system 44 may be configured to determine whether a carriage 24 and/or a working implement 30 is mounted to the working arm 20 (i.e., the working implement mount). Put another way, the control system 44 may be configured to determine whether the working arm assembly includes a carriage 24 and/or a working implement 30. This determination may be based on an output from the camera assembly, or may be determined by any other suitable sensor or means. In such embodiments, the control system 44 may restrict or prevent movement of the working arm assembly to prevent the carriage 24 and/or working implement 30 colliding with the further portion of the working machine 10. Detecting the presence of a carriage 24 and/or working implement 30 helps to prevent the carriage 24 and/or working implement 30 from colliding with and damaging part of the working machine 10. In some embodiments, the control system 44 may be configured to identify the type of carriage 24 and/or working implement 30 that is mounted to the working arm 20, e.g., an identifier on said working implement. This identification of the carriage 24 and/or working implement 30 enables the control system 44 to determine a size and shape of the carriage 24 and/or a working implement 30, which facilitates the prevention of a collision occurring.

In some alternative embodiments, however, the carriage 24 and/or working implement 30 may not be identified. In such embodiments, the control system 44 may be configured to define an outer edge of the carriage 24 and/or working implement 30 and to control or restrict movement of the working arm 20 to prevent this outer edge from impacting or colliding the with the further portion of the working machine 10. In such embodiments, the control system 44 may define a first zone encompassing at least a part of the working arm assembly. It will be appreciated that the first zone may encompass the carriage 24 and/or working implement 30. The size and/or shape of the first zone may be adjusted by the control system 44 based on the identification of the carriage 24 and/or a working implement 30. The control system 44 may also define at least one impact zone corresponding to the at least further one part or portion of the working machine 10. In such embodiments, the relative positions of the first zone and at least one impact zone are determined based on outputs from the camera assembly, and the control system 44 is configured to restrict or prevent movement of the working arm 20 to prevent the first zone from contacting the at least one impact zone. In such embodiments, a boundary of the first zone and the impact zone(s) may be defined to have a predetermined clearance distance from an external surface or a peripheral edge of the respective part of the working machine 10. This predetermined clearance distance helps to define a minimum permitted separation of the two parts of the working machine 10.

As discussed above, the camera assembly may be configured to monitor the ground engaging propulsion structure 16, 18 of the working machine 10. In embodiments where the ground engaging propulsion structure is provided in the form of front and rear wheels 16,18, the control system 44 may be configured to restrict or prevent turning of one or more of said wheels 16, 18 to prevent the wheel 16, 18 from colliding with the working arm assembly.

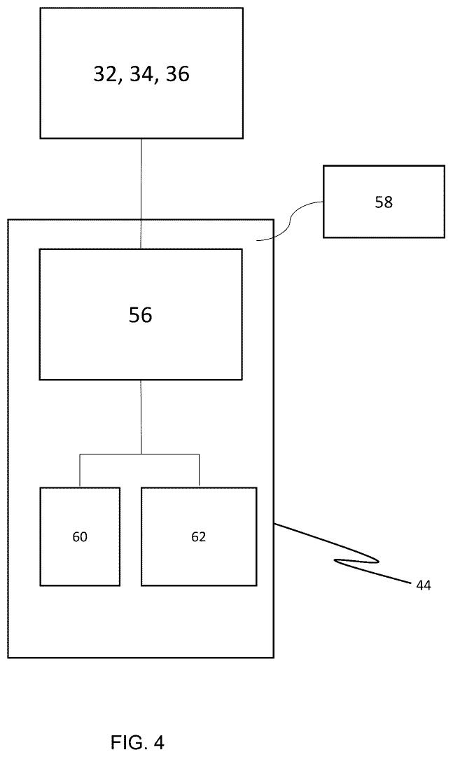

Referring now to FIG. 4, the working machine 10 may be provided with a display 60. The display 60 may be a touch screen display such that the display 60 can be operated as an operator input. In embodiments containing the override control, the override control may be provided on the display 60. The display 60may be positioned within the operator cab 14. The display 60 is configured to display outputs from the camera assembly.

When movement of the working arm assembly has been controlled or restricted by the control system 44, the control system 44 may be configured to select a camera output signal from one or more cameras to display on the display 60 to show the relative positions of the working arm assembly and the further portion of the working machine 10.

In some embodiments, the display 60 may be configured to operate in a plurality of display modes. The display modes may include a camera display mode in which the display is configured to display a camera output from the camera assembly 32, 34, 36 and at least one other display mode. When movement of the working arm assembly has been controlled or restricted by the control system 44, the control system may be configured to override the selection of the at least one other display mode to activate the camera display mode.

In some embodiments, the control system 44 may be configured to activate an alarm or alert 62 when movement of the working arm has been prevented or restricted. In such embodiments, an override control may be provided to disable the alarm or alert. It will be appreciated that the override control to override the alarm or alert may be the same control as previously discussed, or may be a separate override control.

In some embodiments, the control system 44 may include a processor 56 configured to execute a machine learning algorithm trained to determine whether a carriage 24 and/or a working implement 30 is mounted to the distal portion 21 of the working arm 20. The machine learning algorithm comprises a neural network 58. The neural network system 58 includes the processor 56 which receives output signals from the cameras 32, 34, 36. The processor 56 executes a neural network process to determine whether a carriage 24 and/or a working implement 30 is mounted to the distal portion 21 of the working arm 20. In such embodiments, the machine learning algorithm may define the first zone and the impact zone, as discussed above. In some arrangements, the control system 44 may be configured to predict a trajectory of movement of the working arm 20 to determine whether or not a collision is likely to occur based on this determination.

In some embodiments, the processor 56 may be configured to execute a machine learning algorithm to identify whether a load (not shown) is being carried by the working arm assembly. In such embodiments, the control system 44 may be configured to provide a warning, alert, or notification for an operator when the load is within a predetermined distance from the further part of the working machine 10. In some embodiments, the control system 44 may be configured to restrict or prevent movement of the working arm assembly to prevent the load colliding with the at least one further portion of the working machine 10.

In alternative arrangements, it will be appreciated that the machine learning algorithm may be omitted, and the control system may be configured to prevent the distal portion 21 of the working arm 20 colliding with the further portion of the working machine 10, and to generate an output as has been discussed above.

The one or more embodiments are described above by way of example only and it will be appreciated that the variations are possible without departing from the scope of protection afforded by the appended claims.

1. A working machine comprising:
a ground engaging propulsion structure;
a body supported on the ground engaging propulsion structure;
a working arm assembly comprising a working arm pivotally mounted to the body, said working arm comprising a working implement mount at a distal portion thereof;
a sensor assembly arranged to monitor the working arm assembly and at least one further portion of the working machine; and
a control system configured to determine the relative positions of the working arm assembly and the at least one further portion of the working machine based on outputs from the sensor assembly, and to restrict or prevent movement of the working arm assembly to prevent the working arm assembly colliding with the at least one further portion of the working machine.

2. The working machine according to claim 1, wherein the control system is configured to determine whether the working arm assembly comprises a carriage and/or a working implement mounted to the working implement mount based on an output from the sensor assembly, and to restrict or prevent movement of the working arm assembly to prevent the carriage and/or working implement colliding with the at least one further portion of the working machine.

3. The working machine according to claim 2, wherein the control system is configured to identify the type of carriage and/or working implement mounted to the working implement mount.

4. The working machine according to claim 2, wherein the control system comprises a processor configured to execute a machine learning algorithm to identify whether a carriage and/or a working implement is mounted to the working implement mount.

5. The working machine according to claim 4, wherein the processor is configured to execute a machine learning algorithm to identify whether a load is being carried by the working arm assembly, and wherein the control system is configured to provide a warning, alert, or notification when the load is within a predetermined distance from the further part of the working machine, optionally, wherein the control system is configured to restrict or prevent movement of the working arm assembly to prevent the load colliding with the at least one further portion of the working machine.

6. The working machine according to claim 1, wherein the sensor assembly is arranged to monitor at least a part of the ground engaging propulsion structure, and wherein the control system is configured to restrict or prevent movement of the working arm assembly to prevent the working arm assembly colliding with the ground engaging propulsion structure.

7. The working machine according to claim 6, wherein, when the ground engaging propulsion structure is provided in the form of front and rear wheels, the control system is configured to restrict or prevent turning of one or more of said wheels to prevent the wheel from colliding with the working arm assembly.

8. The working machine according to claim 6, wherein the control system comprises a processor configured to execute a machine learning algorithm to identify the ground engaging propulsion structure on the working machine, and to output information on the size and shape of the ground engaging propulsion structure to the control system.

9. The working machine according to claim 1, comprising an operator cab mounted on the body, wherein the sensor assembly is configured to monitor at least a part of the operator cab, and to restrict or prevent movement of the working arm assembly to prevent the working arm assembly colliding with the operator cab.

10. The working machine according to claim 1, wherein the control system is configured to define a minimum permitted distance between the working arm assembly and the at least one further portion of the working machine.

11. The working machine according to claim 1, wherein the control system is configured to provide a gradual stop of the working arm to prevent the working arm assembly colliding with the at least one further portion of the working machine.

12. The working machine according to claim 1, wherein the control system is configured to restrict or limit a speed of movement of the working arm assembly when a spacing between the working arm assembly and the at least one further portion of the working machine is below a first pre-determined distance, optionally wherein the control system is configured to prevent movement of the working arm assembly when a spacing between the working arm assembly and the at least one further portion of the working machine is below a second pre-determined distance, which is less than the first predetermined distance.

13. The working machine according to claim 1, wherein the control system is configured to restrict or prevent movement of the working arm assembly by controlling or restricting one or more of: raising of the working arm; lowering of the working arm; extension or retraction of the working arm, when the working arm is a telescopic working arm; and crowding or dumping of a carriage and/or working implement, when the working arm assembly comprises said carriage and/or working implement.

14. The working machine according to claim 1, wherein the body comprises an undercarriage and a superstructure rotatably mounted to the undercarriage, and wherein the working arm is pivotally mounted to the superstructure, optionally wherein the control system is configured to restrict or prevent rotational movement of the superstructure to restrict or prevent movement of the working arm assembly.

15. The working machine according to claim 1, wherein the control system is configured to define a first zone encompassing a part of the working arm assembly and to define at least one impact zone corresponding to the at least further one part or portion of the working machine, and to determine the relative positions of the first zone and at least one impact zone based on outputs from the sensor assembly, and to restrict or prevent movement of the working arm assembly to prevent the first zone from contacting the at least one impact zone.

16. The working machine according to claim 1, wherein the control system comprises an override control to allow the working arm assembly to be moved in a direction away from the at least one further portion of the working machine, optionally wherein the control system is configured to determine a permitted movement of the working arm assembly way from the at least one further portion of the working machine based on outputs from the sensor assembly.

17. The working machine according to claim 16, wherein the control system is configured to automatically reverse a direction of travel of the working arm assembly to move the working arm assembly in a direction away from the at least one further portion of the working machine.

18. The working machine according to claim 1, wherein the sensor assembly comprises a camera assembly comprising at least one camera.

19. The working machine according to claim 18, comprising a display configured to display outputs from the camera assembly, optionally wherein the display is configured to operate in a plurality of display modes comprising a camera display mode in which the outputs from the camera assembly are displayed and at least one other display mode, and wherein, when movement of the working arm assembly has been restricted or prevented, the control system is configured to override the selection of the at least one other display mode to display the relative positions of the working arm assembly and the at least one further portion of the working machine.

20. The working machine according to claim 1, comprising an alarm or alert, and wherein the control system is configured to activate the alarm or alert when movement of the working arm assembly has been prevented or restricted.
